(19) United States
(12) Patent Application Publication
(10) Pub. No.: US 2022/0379556 A1
(43) Pub. Date: Dec. 1, 2022

(54) Apparatus and Method for Producing a Three-Dimensional Shaped Object

(71) Applicant: dp polar GmbH, Eggenstein-Leopoldshafen (DE)

(72) Inventor: Hans Mathea, Eggenstein-Leopoldshafen (DE)

(21) Appl. No.: 17/775,777

(22) PCT Filed: Nov. 17, 2020
(86) PCT No.: PCT/EP2020/082446

§ 371 Date: May 10, 2022

(30) Foreign Application Priority Data
Nov. 17, 2019 (DE) 10 2019 007 953.1
Nov. 18, 2019 (DE) 10 2019 007 972.8

(51) Int. Cl. B29C 64/188; B33Y 10/00; B33Y 50/02; B33Y 30/00; B29C 64/393

(52) U.S. Cl. CPC B29C 64/188; B33Y 10/00; B33Y 50/02; B33Y 30/00; B29C 64/393

(57) ABSTRACT

The invention relates to an apparatus and to a method for producing a three-dimensional shaped object by means of material application in layers Sₙ (n=1 to N), which has at least a material dispensing device, a drive device, a print substrate, a control device having a data memory, and a material removal device. In order to be able to recognize and eliminate defects in a layer Sₙ, which can still occur later, i.e., after completion of this layer Sₙ, it is proposed, according to the invention, to provide a monitoring device. Furthermore, a downstream evaluation device determines a layer Sₓ in which the at least one defect was detected. Thereupon an error signal is generated and passed on to the control device. The material removal device completely removes the material of a partial region of the shaped object, from the layer S_{N} that was last printed, down to the first of the defective layers Sₓ. Building up the three-dimensional shaped object begins anew at the layer Sₓ₋₁.

### CROSS-REFERENCE TO RELATED APPLICATIONS

This application is the United States national phase of International Application No. PCT/EP2020/082446 filed Nov. 17, 2020, and claims priority to German Patent Application Nos. 10 2019 007 953.1 filed Nov. 17, 2019 and 10 2019 007 972.8 filed Nov. 18, 2019, the disclosures of which are hereby incorporated by reference in their entirety.

### BACKGROUND OF THE INVENTION

### Field of the Invention

The invention relates to an apparatus for producing a three-dimensional shaped object by means of applying material application in layers, which apparatus has at least one material dispensing device for applying material that can be solidified physically or chemically, to a print substrate or to a solidified layer of the shaped object situated on it; a drive device for positioning the print substrate and the at least one material dispensing device relative to one another; and a control device having a data memory for storing image data of the three-dimensional shaped object, wherein the control device stands in a control connection with the drive device and the at least one material dispensing device. Furthermore the apparatus has a monitoring device for checking the layers Sₙ of the three-dimensional shaped object, wherein the monitoring device is followed by an evaluation device. The apparatus furthermore has a material removal device, wherein the evaluation device and the material removal device stand in a control connection with the control device, and the material dispensing device is followed by a leveling device for leveling the layer Sₙ that is applied, in each instance.

### Description of Related Art

Furthermore the invention relates to a method for producing a three-dimensional shaped object by means of material application in layers Sₙ, where n=1 to N, having the following steps:
applying material that can be solidified physically or chemically to a print substrate in layers Sₙ;
checking the three-dimensional shaped object with regard to at least one existing defect;
leveling each layer Sₙ that is applied, in each instance;
   determining a layer Sₓ of the three-dimensional shaped object, in which layer the at least one defect was detected;
   checking the subsequent layers Sₙ, where n=x+1, x+2 . . . , for defective geometry changes of the shaped object.

In the sector of the additive method by means of layer-by-layer material application, the document EP 3 294 529 B1, is known, for example, which relates to an apparatus and a method for producing three-dimensional shaped objects. The apparatus shown in this document applies material to a rotatable print substrate, and produces the three-dimensional shaped object at a high speed and with high print quality. If a defect in the three-dimensional shaped object were to occur during the printing process, the entire shaped object must be disposed of as scrap, and the printing process must be started over again. If the defect only occurs at the end of a printing process, the loss is greater than at the beginning of the printing process. This can lead to high, even very high costs, depending on the size of the object to be printed. Accordingly, the production times increase, and this in turn leads to higher costs. It is not only the fact that financial losses occur, but also environmental considerations play a role, if large amounts of material have to be destroyed.

In order to counter this, a correction process is proposed, for example in DE 10 2017 208 497 A1, which corrects each printed layer of the three-dimensional component at an early point in time, i.e., immediately, if a defect has occurred during printing. The correction is dependent on the type of defect that has occurred. For example, if too little material was applied in a region of the component, in the correction process a material application process is carried out only for this specific region. The correction process also comprises the possibility that in the case of defective locations having only a small dimension, no correction of the defective location takes place, but rather an adaptation of the subsequent machine code takes place. If, for example, too much material was applied in one region of the component, this material excess can be removed by means of grinding and/or milling. However, in the case of this document it is disadvantageous that the method takes a lot of time, since new calculations must take place for every subsequent layer, and this leads to time-outs during printing. Furthermore, a correction process is defined for every type of defect, so that a distinction is made between the different types of defects. The time expended for determining the individual types of defects is disadvantageous, and the proposed repair measures, such as material filling in the case of a lack of material, mean a loss of quality of the component.

Correction processes by means of material removal are also known from US 2018/0 071 987 A1 and US 2018/0 361 668 A1.

### SUMMARY OF THE INVENTION

Proceeding from the known prior art, the invention is based on the task of further developing an apparatus and a method of the type stated initially, to the effect that the disadvantages from the prior art are eliminated, the productivity of the production process is increased, and nevertheless a high quality of the three-dimensional shaped object is made possible.

The following definitions are used:

### Printing Process

In this connection, a printing process is understood to be the application of material in layers, so as to produce a three-dimensional shaped object.

### Material Dispensing Device

A material dispensing device is understood to be a device by means of which a liquid, paste-form, powder-form or gaseous material that can be solidified can be applied, layer by layer, onto the print substrate or onto a solidified layer of the shaped object situated on it. The material dispensing device can be structured for dispensing material portions, in particular as an ink-jet print head.

### Dismantling Process

The dismantling process is the use of the material removal device for layer-by-layer removal of material of the three-dimensional shaped object. This removal takes place in complete layers, in other words the entire printed surface, and can remove one or more layer thicknesses in one pass. New printing takes place after the dismantling process.

### Layer S

A layer means a material layer that is applied by the material dispensing device to the print substrate or to a layer that has already been applied.

### Lowermost Layer

The lowermost layer, having the index n=1, is the first layer that is applied to the print substrate by the at least one material dispensing device.

### Uppermost Layer S_{N}

The uppermost layer, having the index N, is the last layer that was applied by the at least one material dispensing device to the preceding layer having the index N−1 before the printing process is stopped. The printing process is stopped when a defect is detected or when the shaped object was finished.

### Defective Layer Sₓ

The defective layer is an individual first layer having the index n between n=1 and N, in which a defect occurred that is eliminated by means of material removal, wherein this defect has effects on the subsequent layers. Therefore, the layers applied one on top of the other, following the individual first layer, are also defective.

### Partial Region T

A partial region T consists of the layers to be removed, having the index N to x (from the uppermost layer down to the defective layer).

### Defect

In this connection, the term defect is used in such a manner that defective locations in the three-dimensional shaped object are involved. Examples to be mentioned are defective locations that contain too little material, such as lack of material, shrinkage of the material, or the like, where the dimensions and the form of a layer can change.

### Slicer Indicator

The slicer indicator Z_{S} points to the memory location that contains the data for each individual layer, with the corresponding coordinates, layer thickness of the layer, etc., which were generated for the 3D model filed in the image data memory.

### Object Indicator

The object indicator Z_{O} shows the position of the currently built-up or removed layer. As long as the material application proceeds without defects, the object indicator Z_{O} and slicer indicator Z_{S} proceed synchronously and point to the same layer. In the event of a defect, in which the dismantling process is activated, the object indicator Z_{O} follows the slicer indicator Z_{S}, specifically layer by layer, until the object indicator Z_{O} reaches the position of the slicer indicator Z_{S}.

The task mentioned above is accomplished, with reference to the apparatus of the type stated initially, in that the evaluation device is configured for determining a layer Sₙ where n=x, in which at least one defect was detected by the monitoring device, for checking the layers Sₙ where n=x+1, x+2 . . . that follow the defective layer Sₓ for a defective geometry change of the shaped object, which exceeds a predetermined dimension, for generating an error signal for the layer Sₓ in the event of a defective geometry change of the subsequent layers Sₙ where n=x+1, x+2, . . . , and for passing the error signal that was generated on to the control device for this first one of the defective layers Sₓ; that the material removal device is structured for removing the material of a partial region (T) of the three-dimensional shaped object from the last layer S_{N} printed down to the defective layer Sₓ, and that the evaluation device [incomplete clause], wherein the material removal device is configured in such a manner that during removal of the material, complete layers Sₙ can be removed.

The fact that a leveling device follows the material dispensing device has the advantage that a defect with a material excess, in other words too much material that was applied, cannot occur. By means of the leveling device, the layer thickness is automatically restricted. This means that an overly high amount of material is leveled out, and the defect of “material excess” therefore does not have to be corrected. It is advantageous if the leveling takes place immediately after application of the material, while it is still liquid, so that the material removal device, which removes the material that has already solidified, does not come into use. It is advantageous if the printing process is not restricted in terms of speed and productivity by a correction of this type of defect. The fact that the monitoring device checks the three-dimensional shaped object with regard to at least one existing defect has the advantage that the different types of defects, such as a lack of material or geometry changes or volume changes due to shrinkage of the material of the applied layers Sₙ can be recognized. It is advantageous if an evaluation device follows. The subsequent evaluation device determines a layer Sₙ (n=x) in which the at least one defect was detected by the monitoring device. It is advantageous if this is a layer Sₙ onto which at least one further layer Sₙ₊₁ was already applied. For this reason, the printing process can advantageously be continued in the usual manner, without stopping the printing process after every defect detection in a layer Sₓ and removing the defective layer Sₓ. In these layers Sₙ where (n=x+1, x+2 . . . ), which follow the defective layer Sₓ, the effect of the defect of the defective layer Sₓ shows up. The printing process is thereby advantageously given time to even out certain defects that do not subsequently have any effect on the geometry of the shaped object. Only if the defect that occurred in the layer Sₓ brings about a geometry change in the subsequent layers that exceeds a predetermined dimension does the evaluation device generate an error signal for this defective layer Sₓ. For example, in the event of a volume change of the material that leads to shrinkage. It is advantageous if a defective geometry change is detected by the monitoring device, and if an error signal is accordingly brought about by the evaluation device for this first one of the defective layers Sₓ that brings about a geometry change in the subsequent layers Sₙ, and passed on to the control device, so that the latter then stops the printing process. It is advantageous that in this way, not every layer is corrected, which would enormously increase the production time of the shaped object, because checking and evaluating and determining the position of the defect, determining a suitable correction measure, and finally eliminating the defect takes a lot of time. A correction only takes place after a predetermined dimension is exceeded.

It is advantageous if the material removal device removes the material of a partial region (T) of the three-dimensional shaped object from the last layer S_{N} that was printed, down to the defective layer Sₓ for which an error signal was generated. The material removal device and the evaluation device stand in a control connection with the control device. As a result, all the layers down to the defective layer Sₓ are removed. Further layers have already been applied to the defective layer Sₓ. Therefore not only the uppermost layer S_{N} is removed, but also a partial region T of layers. This has the advantage that the defective shaped object can always be corrected and does not have to be disposed of.

It is advantageous if the partial region T of the three-dimensional shaped object comprises one preferably complete layer Sₙ, from the last layer S_{N} that was printed down to the defective layer Sₓ, in particular between two and four preferably complete layers Sₙ, preferably more than four preferably complete layers Sₙ. In this way it is possible to carry out the dismantling process efficiently and without time loss, in a speedy manner, since removal, in other words dismantling of each individual layer, is time-consuming and relatively expensive due to cost-intensive evaluation intelligence, and this would make the production process of the three-dimensional shaped object as a whole more expensive.

It is advantageous if the material removal device is configured in such a manner that complete layers n can be removed during removal of the material. As a result, a repair, such as material filling in an individual layer in the case of the defect “lack of material,” for example, is not necessary, since the entire layer Sₙ is always removed by the material removal device. Therefore, no distinction is made between the individual types of defects, but rather a dismantling process is used for all types of defects, which process does not remove the individual layer partially, but rather completely. This simplifies the evaluation and accelerates the process.

It is advantageous if the material removal device is configured for chip-removing machining, in particular by means of milling, preferably polishing, grinding and/or scraping.

It is advantageous if the material removal device is configured in such a manner that during removal of the material, the thickness of a layer Sₙ or the thickness of at least two layers Sₙ can be removed, preferably completely. In this way, as many layers Sₙ as desired can be removed, and the dismantling process can be used in an accelerated manner.

It is advantageous if the monitoring device is configured as an optical monitoring device, in particular a CCD camera, a CCD camera in combination with a laser beam, an optical or mechanical scanning device, a device that measures layer thickness, or a measuring laser. In this way, defective layers Sₓ can be detected with great precision.

It is advantageous if the material dispensing device is configured in such a manner that it can be brought into a parked position, in which a service station for checking a functional disturbance of the material dispensing device and for eliminating the possible functional disturbance is arranged. Therefore, the material dispensing device can be serviced, so as to correct possible problems that impair its function, while the material removal device is removing the partial region that has the defective layers. If necessary, the material dispensing device can also simply be replaced with a corresponding replacement part if the error signal occurs.

It is advantageous if the print substrate is mounted so as to rotate about an axis of rotation relative to the at least one material dispensing device, so that the print substrate can be continuously moved during the entire printing process. This allows faster progress of printing.

It is advantageous if the drive device is configured for positioning the material dispensing device relative to the print substrate, which stands in a fixed location in the vertical direction, or for positioning the print substrate relative to the material dispensing device, which stands in a fixed location in the vertical direction. Because of the fact that multiple layers Sₙ are printed before it is decided whether or not the dismantling process is initiated, the printing speed can be maintained without any interruption.

In a further advantageous embodiment, the material removal device has a material removal tool for chip-removing machining of the shaped object, wherein the material removal tool spans the print substrate in at least one expanse, in such a manner that the material removal device completely removes the layers S_{N} to Sₓ. In this way, the apparatus can remove the full, in other words complete surface area of the defective layers of the shaped object that has already been partially printed, in a very efficient, effective, and rapid manner, in one work pass. The removal always takes place over the entire printed surface, in other words the surface area of a complete layer. The number of layers that are removed in one work pass is based on the partial region T that was previously determined.

It is advantageous if the material removal device and print substrate can be moved relative to one another by a height that is predetermined by the evaluation device on the basis of the partial region T of the defective layers S_{N} to Sₓ of the shaped object, and the material removal tool removes the complete layers S_{N} to Sₓ in one work step. Therefore, rapid machining times are possible in the dismantling process, since the material removal device is moved over the shaped object only once in order to remove the defective layers.

It is advantageous if the material removal tool of the material removal device has a longitudinal expanse along an axis, which expanse is configured to be cylindrical or conical, and if it can rotate about its own axis. In this way the material removal device can be used both in the Cartesian and in the polar printing process. In the case of the conical configuration of the oblong material removal tool of the material removal device, the cone extends to the outer circumference of the rotating print substrate. Therefore, the higher speed at the outside circumference of the print field is taken into consideration, and no inaccuracies occur.

The task stated above is accomplished, with reference to the method of the type stated initially, in that
an error signal is generated for this first one of the defective layers Sₓ and passed on to a control device if a defective geometry change of the subsequent layers Sₙ where n=x+1, x+2 . . . was detected, which change exceeds a predetermined dimension;
the material application in layer S_{N} is stopped in accordance with the error signal;
in the image data of the shaped object, a slicer indicator (Z_{S}) is set to the first defective layer Sₓ;
a partial region (T) of the three-dimensional shaped object is removed from the last layer S_{N} that was printed, down to the defective layer Sₓ for which an error signal was generated, wherein the layers S_{N} to layer Sₓ are completely removed, and
afterward the layers that were previously removed, and possible further layers are applied and checked, layer by layer, until completion of the shaped object.

The advantages of the solution in terms of method as described herein corresponds to the advantages mentioned above with reference to the apparatus. Further advantageous embodiments of the method of the invention are indicated in the dependent claims.

### BRIEF DESCRIPTION OF THE DRAWINGS

Further details, characteristics, and advantages of the present invention will become evident from the following description of the exemplary embodiments of an apparatus for producing a three-dimensional shaped object, making reference to the drawings.

The figures show:

FIG. 1 a schematic representation of the apparatus in an arrangement according to a first exemplary embodiment,

FIG. 2 a side view of a shaped object and of a related image data model in the printing process,

FIG. 3 a side view of the shaped object and of the related image data model after defect detection,

FIG. 4 a side view of the shaped object and of the related image data model at the beginning of the dismantling process of a first exemplary embodiment,

FIG. 5 to

FIG. 8 a side view of the shaped object and of the related image data model of the first exemplary embodiment during the dismantling process,

FIG. 9 a side view of the shaped object and of the related image data model of the first exemplary embodiment after the dismantling process,

FIG. 10 a side view of the shaped object and of the related image data model of the first exemplary embodiment at the beginning of the new printing process,

FIG. 11 a side view of the shaped object and of the related image data model of the first exemplary embodiment after completion of the new printing process,

FIG. 12 a schematic representation of the apparatus in an arrangement according to a second exemplary embodiment,

FIG. 13 a side view of the shaped object and of the related image data model at the beginning of the dismantling process of the second exemplary embodiment,

FIG. 14 a side view of the shaped object and of the related image data model of the second exemplary embodiment after the dismantling process,

FIG. 15 a side view of the shaped object and of the related image data model of the second exemplary embodiment at the beginning of the new printing process,

FIG. 16 a side view of the shaped object and of the related image data model of the second exemplary embodiment after completion of the new printing process,

FIG. 17 a perspective side view of the material removal device with a cylindrical material removal tool,

FIG. 18 a perspective side view of the material removal device with a conical material removal tool, and

FIG. 19 a top view of the material removal device according to FIG. 18.

### DESCRIPTION OF THE INVENTION

In the following, the invention will be described in detail in the form of exemplary embodiments, using the aforementioned figures. In all the figures, the same technical elements are identified with the same reference symbols.

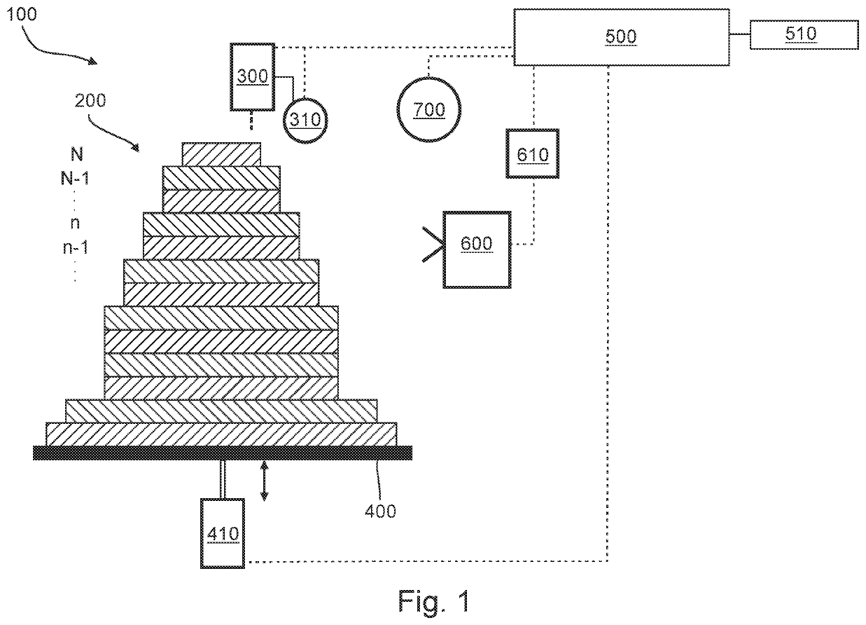

FIG. 1 shows an apparatus 100 according to the invention in an arrangement according to a first exemplary embodiment. The apparatus 100 serves to produce a three-dimensional shaped object 200 and to remove a partial region T of the shaped object 200, which has a defective layer Sₓ. The three-dimensional shaped object 200 is applied in layers Sₙ. For this purpose, the apparatus 100 has a material dispensing device 300 for applying the material in layers Sₙ. The first layer Sₙ where n=1 is applied to a print substrate 400. The material dispensing device 300 is followed by a leveling device 310 which prevents a material excess from forming on the applied layer Sₙ. Furthermore, the apparatus 100 has a material removal device 700 for removing a partial region T of the applied material from the uppermost layer S_{N} down to a defective layer Sₓ, where x: {1, . . . , N}. In the following we will speak of the first layer Sₙ applied to the print substrate 400, where n=1, as the lowermost layer. The last layer S_{N} applied is referred to as the uppermost layer. The uppermost layer S_{N} can be the last layer with which the three-dimensional shaped object 200 was completed, or any desired layer before completion of the shaped object 200, at which the printing process is interrupted due to defect detection. Both the material dispensing device 300 and the material removal device 700 are controlled by a control device 500. The control device 500 has a data memory 510, in which image data 210, as shown in the following figures, of the three-dimensional shaped object 200 to be produced have been stored. Furthermore, the control device 500 controls a drive device 410 that positions the print substrate 400 and the material dispensing device 300 relative to one another. In this first exemplary embodiment, the drive device 410 positions the print substrate 400 relative to the material dispensing device 300, which is configured to be fixed in place in the vertical direction. This takes place in such a manner that during the layer-by-layer material application in layers Sₙ, the print substrate 400 is moved downward in the vertical direction, and during layer-by-layer material removal of the layers S_{N} to x, the print substrate 400 is moved upward in the vertical direction, in the direction of the material removal device 700, which is also configured to be fixed in place in the vertical direction in this exemplary embodiment. The movement direction of the print substrate 400, which is brought about by means of the drive device 410, is symbolized with vertical double arrows.

Furthermore, the apparatus 100 of the first exemplary embodiment shown in FIG. 1 has a monitoring device 600, which is followed by an evaluation device 610. The monitoring device 600 checks the three-dimensional shaped object 200 for possible defects that have occurred.

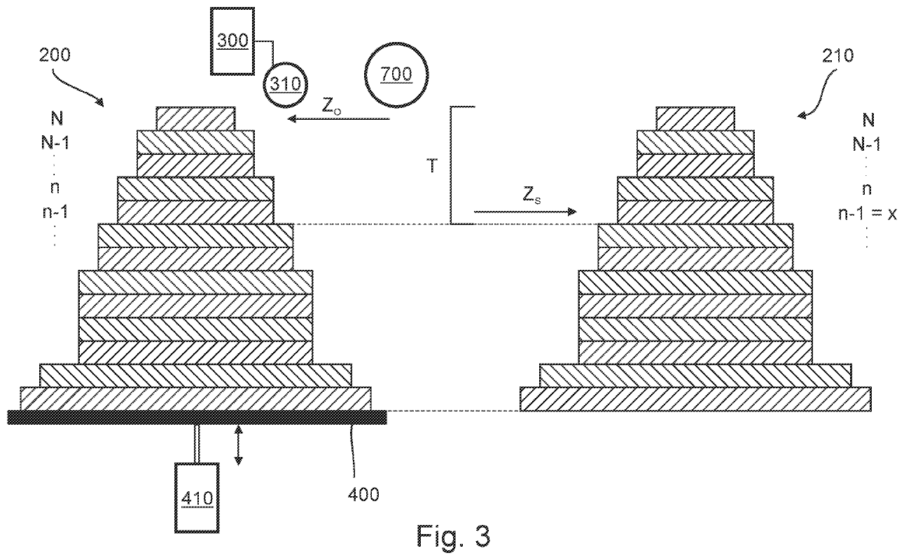

In order to detect and correct a damaged, i.e., defective layer Sₓ, which might occur during the printing processes, in or on the three-dimensional shaped object 200, the three-dimensional shaped object 200 is checked by the monitoring device 600. For example, the defect is recognized by means of a comparison of the shaped object 200, which was formed from multiple layers Sₙ to N, with the predetermined image data of the three-dimensional shaped object 200, which are stored in the data memory 510. The evaluation device 610 arranged between the monitoring device 600 and the control device 500 evaluates the detected defect and assigns a layer Sₓ where x: {1, . . . , N} to the defect found by the monitoring device 600. The evaluation device 610 checks the subsequent layers Sₙ where (n=x+1, n=x+2, etc.) for a defective geometry change of the shaped object 200, which change exceeds a predetermined dimension, and thereupon generates an error signal. The error signal generated for this first one of the defective layers Sₓ is passed on to the control device 500. The printing process is stopped by the control device 500, because a defect has occurred in a layer Sₙ, which defect has effects on the subsequent layers, and a dismantling process for removing the material of a partial region T of the previously printed three-dimensional shaped object 200 is initiated. This dismantling process is described in FIGS. 3 to 8.

In the case of alternative embodiments, the monitoring device 600 and the evaluation device 610 can be replaced by inspection personnel. Other than that, the apparatus 100 according to the invention functions as in the case of the first and second exemplary embodiment. The inspection personnel or monitoring personnel detect the defect on the basis of their technical knowledge, and enter the data for this first one of the defective layers Sₓ by way of an input terminal, so that the control device 500 processes the data that have been input further, as described above. In this regard, the inspection personnel can undertake entry of the depth of the material to be removed also by means of thickness information (displacement path for the milling device in the Z axis) in millimeters, and the control device (500) calculates how many layers fit into the indicated millimeter entry, and sets the slicer indicator Z_{S} to the calculated position of the layer Sₓ.

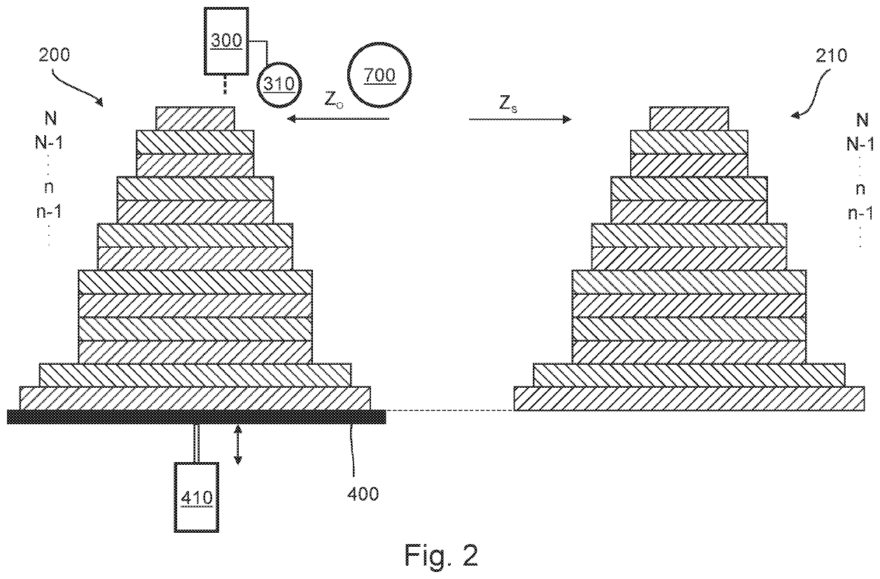

FIG. 2, on the left side, shows the three-dimensional shaped object 200, and, on the right side, shows the corresponding image data 210 of the shaped object 200. Schematically, an object indicator Zₒ and a slicer indicator Z_{S} are shown. The slicer indicator Z_{S} detects the layer data of a layer Sₙ that is to be printed in accordance with the image data 210. The object indicator Zₒ, which corresponds to the corresponding layer Sₙ on the printer side, follows the slicer indicator Z_{S}, so as to control, i.e., position the material dispensing device 300 accordingly. In this way, the layers Sₙ of the shaped object 200 are printed in accordance with the image data 210. Once a layer Sₙ₋₁ has been completely printed, the slicer indicator Z_{S} jumps to the next layer Sₙ to be printed, and the object indicator Zₒ follows, so that the layer Sₙ is applied to the layer Sₙ₋₁. This process is continued until the three-dimensional shaped object has been completed, or a defect is detected by the monitoring device 600 or the inspection personnel.

FIG. 2 shows a defect-free printing process, in which the three-dimensional shaped object 200 was printed without defects and all the layers Sₙ where n=1 to n=N were built up correctly. To apply the material, the print substrate 400 according to the first exemplary embodiment was moved vertically. This representation and the representations of the shaped object 200 as well as of the image data 210 in the following figures apply analogously for the second exemplary embodiment and for the alternative embodiments of the apparatus 100 as described above.

Starting from FIG. 3, it is assumed that the monitoring device 600 or the monitoring/inspection personnel has detected a defect that has effects on the subsequent layers. The corresponding layer Sₙ is assigned to this defect by means of the evaluation device 610. As an example, let us assume that the defect is situated in the layer Sₙ₋₁ of the printed shaped object 200. The printing process is stopped. The slicer indicator Z_{S} of the image data 210 is set to the first one of the defective layers Sₓ, here to the layer Sₙ₋₁ that was chosen as an example.

As soon as the printing process is stopped because a defect occurred in a layer Sₙ, the material dispensing device 300 is moved to a parked position and releases the working position for the material removal device 700. In this way, a dismantling process for removing the material of a partial region T of the previously printed three-dimensional shaped object 200 is initiated.

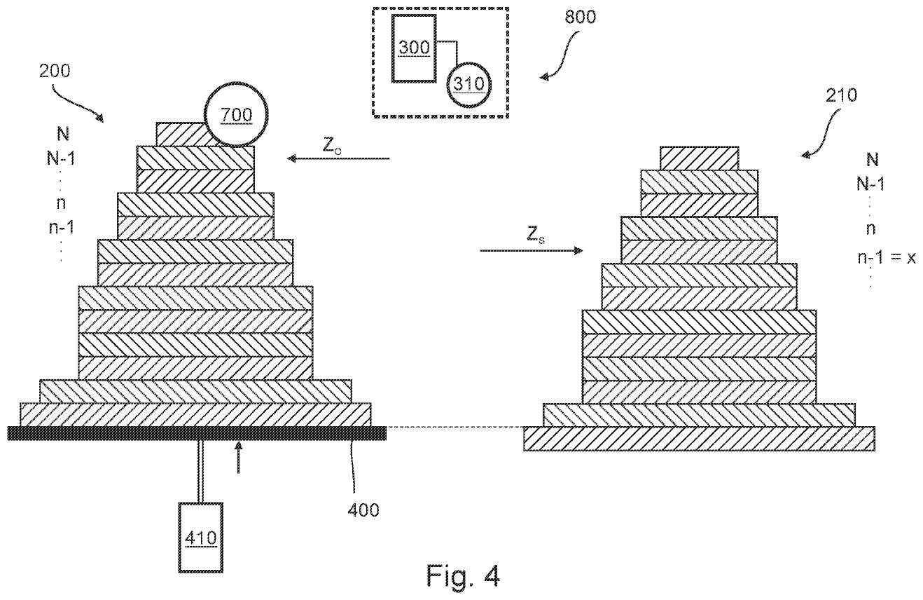

While the material dispensing device 300 is in the parked position, it is checked by the service device for any functional problems. The service that is performed by the service device eliminates the problem, so that after removal of the defective layers, in other words after the dismantling process as described in the following, the material dispensing device 300 can apply the material layer by layer, without problems. This dismantling process will be described using FIGS. 4 to 8.

In FIG. 4, the material removal device 700 is already in the working position, so as to remove the material of the corresponding partial region T. In this example, the partial region T comprises the layers n to n−1. The object indicator Zₒ contains the data of the corresponding layer that is being removed and follows the slicer indicator Z_{S}. Likewise, depending on the properties of the material removal device 700, one or more layers Sₙ can be removed in a layer-by-layer working pass of the dismantling process. As an example, removal of one layer Sₙ, in each instance, is shown in this and in the following figures.

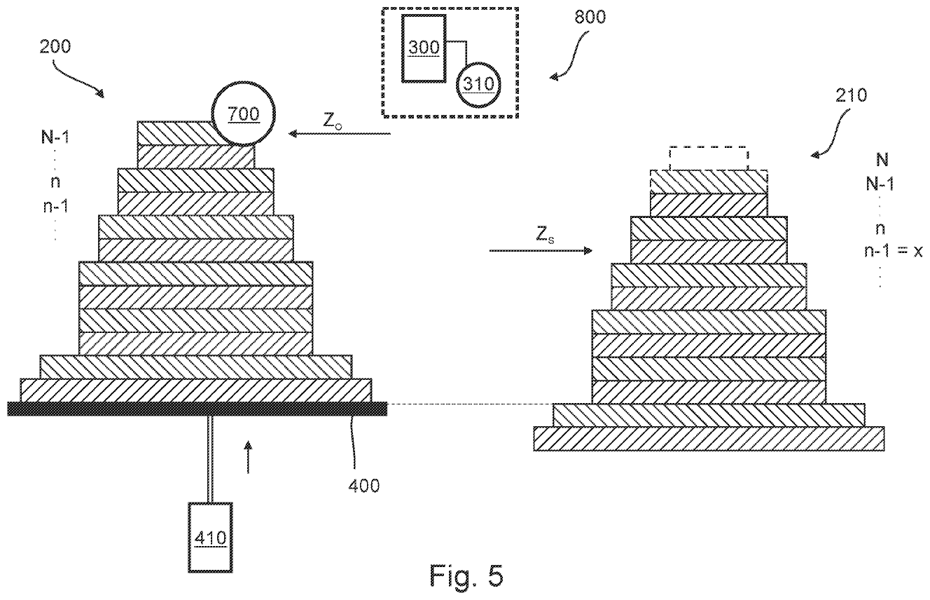

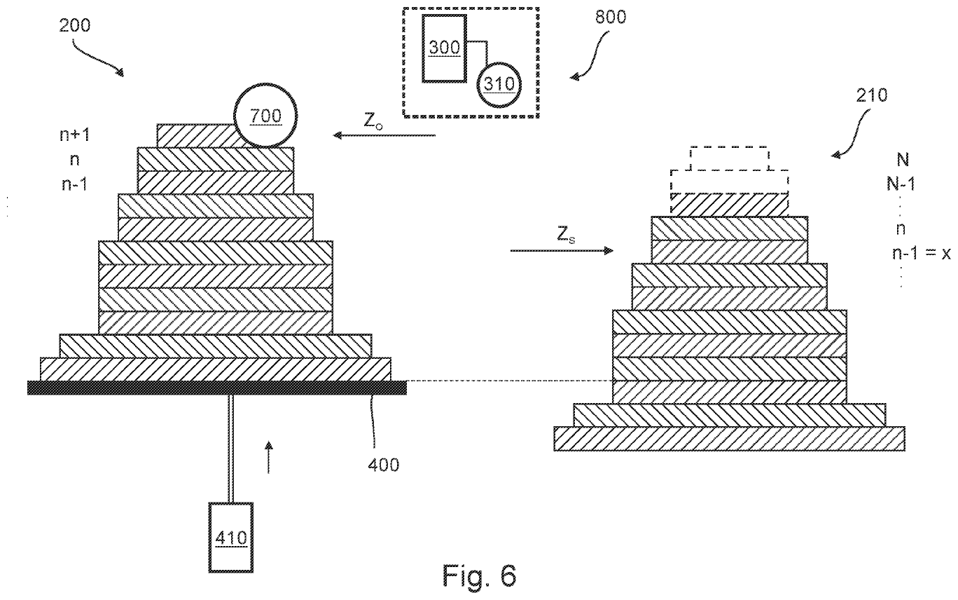

According to FIG. 5, the object indicator Zₒ continues to follow the slicer indicator Z_{S}, which stands on the defective layer n−1 until it is removed. FIG. 5 shows the dismantling process for the layer N−1, since the layer N has already been removed. For this purpose, the print substrate 400 was moved, by the drive device 410, to the height of the material removal device 700, in other words, in this example, vertically upward by one layer thickness of the printed shaped object 200, since here one layer thickness, in each instance, is being removed as an example. Analogous to FIG. 5, in FIG. 6 the print substrate 400 is moved further vertically upward by the drive device 410, so that the next layer Sₙ₊₁ of the shaped object 200 can be removed by the material removal device 700. The broken-line layers S_{N} and S_{N-1} of the image data 210 on the right side of the figure indicate that these layers S have already been removed.

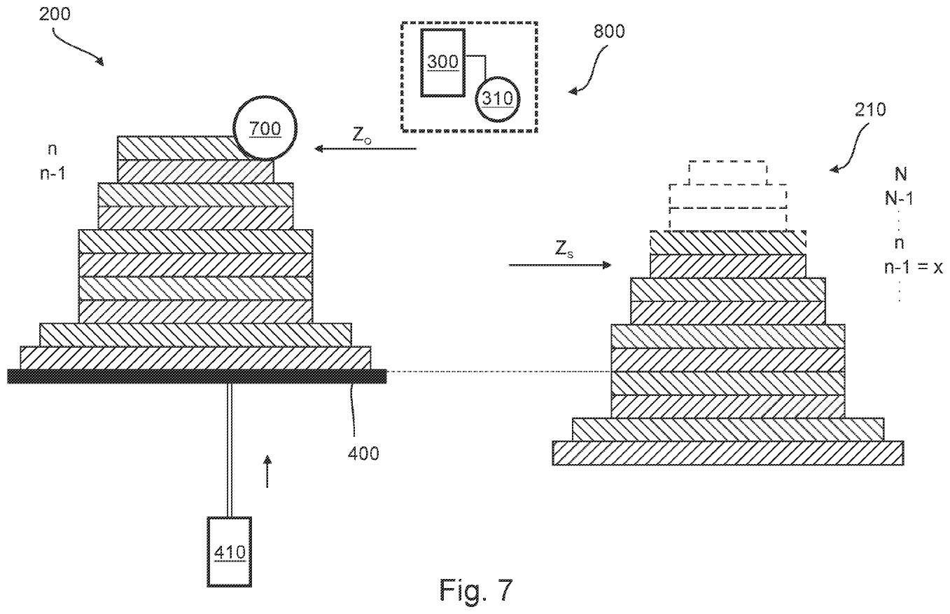

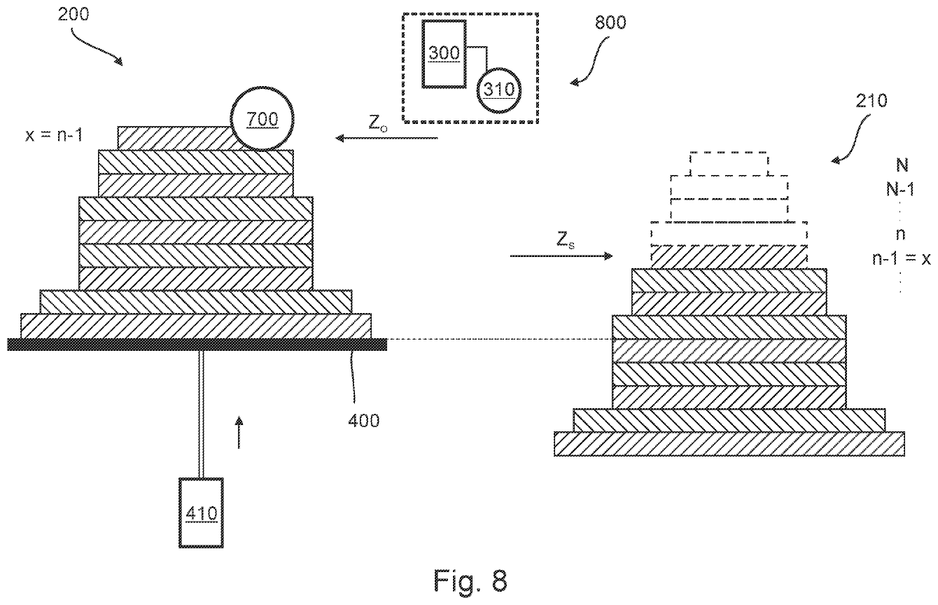

The dismantling process is continued in accordance with the process described above, so as to remove the layers, individual ones or multiple ones. This is shown schematically in FIG. 7 for the layer n and in FIG. 8 for the layer x=n−1. Only when the object indicator Zₒ and the slicer indicator Z_{S} stand on the same layer, here n−1, is the material removal device 700 stopped once again. In this way, it is guaranteed that all the layers down to the detected defective layer Sₓ with x=n−1 were completely removed, and the dismantling process is terminated.

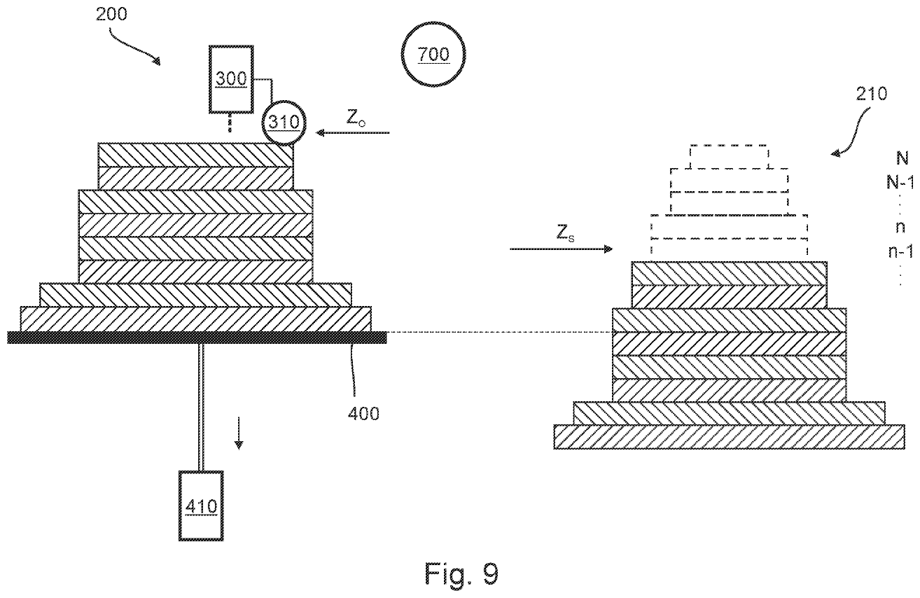

The material removal device 700 is moved to a parked position, and the material dispensing device 300 is moved to the working position, as shown in FIG. 9 for the first exemplary embodiment. Since the shaped object 200 was defective, the printing process now has to be started over again, so as to produce a defect-free shaped object 200.

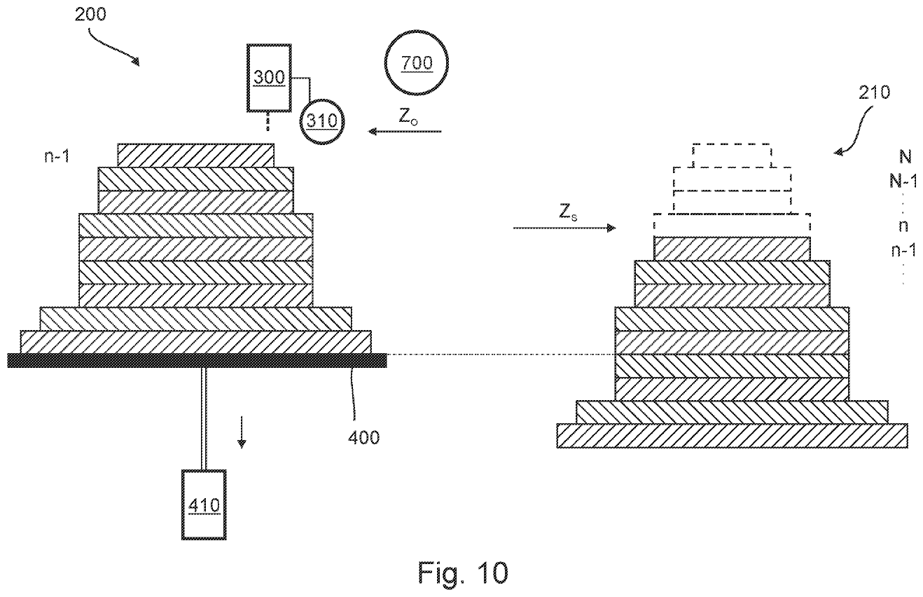

FIG. 10 illustrates the printing process using the first exemplary embodiment. As can be seen in the representation of the three-dimensional shaped object 200 on the left, in each instance, the previously first one of the defective layers Sₓ with x=n−1 was re-applied by the material dispensing device 300 and leveled, in other words smoothed by the leveling device 310. In this process, the material removal device 700 was raised or moved aside. The material application process is continued until the shaped object 200 has been printed entirely without defects. The material application continues until the object indicator Z_{O} has reached the position of the slicer indicator Z_{S}.

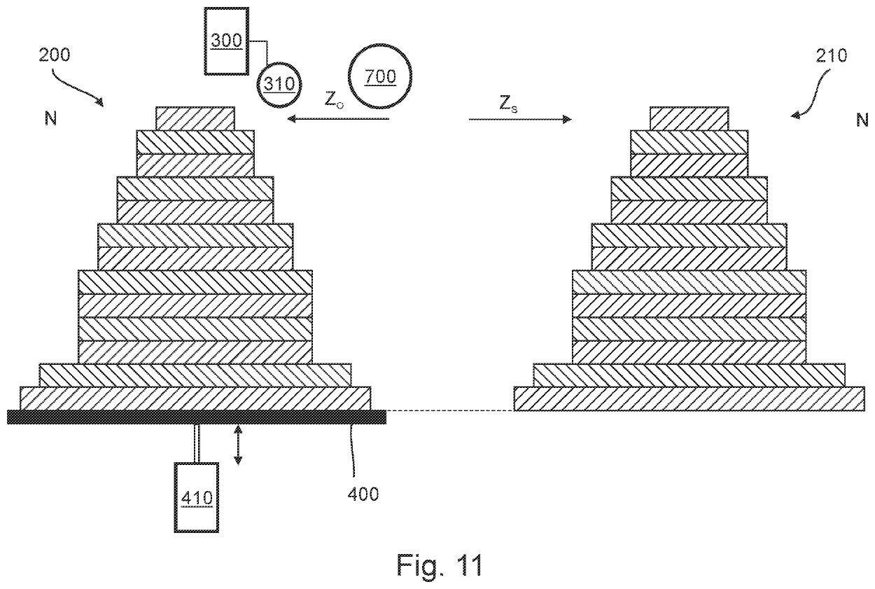

FIG. 11 shows the shaped object 200 after renewed application of the layers n=x to N, in other words at the end of the new printing process. The print substrate 400 has been moved into the starting position again by the drive device 410, and the uppermost layer N has been completely applied. The material removal device 700 is in the parked position. If a defect has been detected before final completion of the shaped object, then the printing process can be continued (after removal of damaged layers) until the shaped object has been entirely completed. During this process, the removed layers are re-applied.

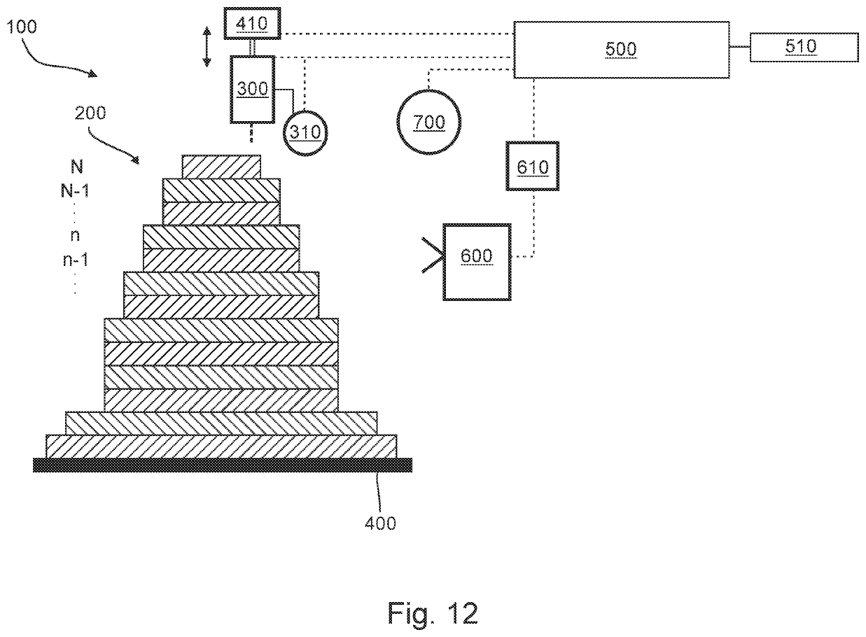

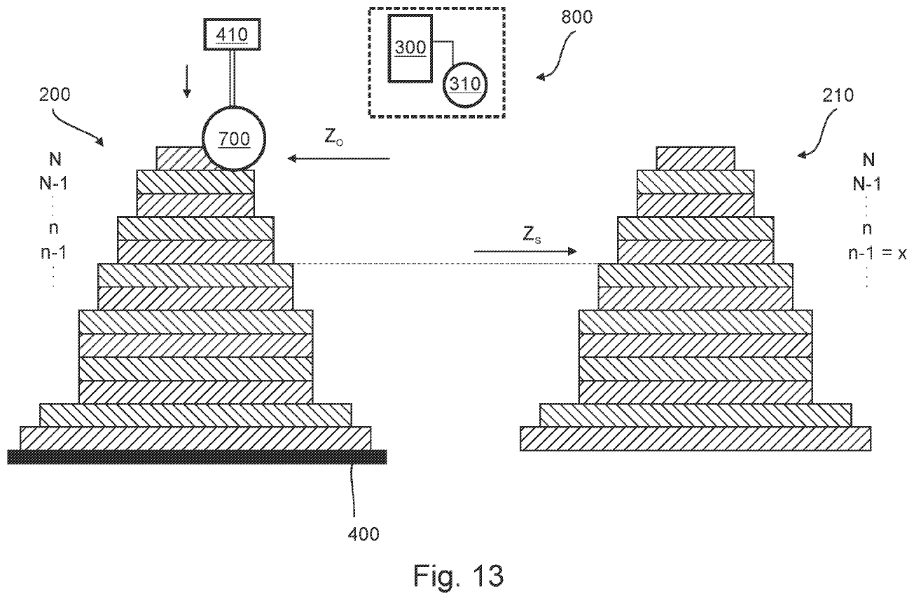

FIG. 12 shows a second exemplary embodiment for positioning the print substrate 400 and material dispensing device 300 relative to one another. In contrast to the exemplary embodiment according to FIG. 1, the drive device 410 in FIG. 12 is arranged on the material dispensing device 300, so as to move it vertically, and the print substrate 400 is configured fixed in place in the vertical direction. The direction of the movement of the material dispensing device 300, which is brought about by the drive device 410, is symbolized with vertical double arrows. In this exemplary embodiment the material dispensing device 300 is moved vertically upward by the drive device 410 during application of the material in layers Sₙ onto the print substrate 400, so as to produce the three-dimensional shaped object 200. During material removal, the drive device 410 moves the material removal device 700 downward in the vertical direction, in the direction of the print substrate 400, as will still be described in greater detail in FIG. 13. Regardless of the alternative placement of the drive device 410 as shown in this figure, the apparatus 100 functions in precisely the same manner as described with reference to FIG. 1.

In FIG. 13, the beginning of the dismantling process is shown for the second exemplary embodiment. In the case of the second exemplary embodiment, it is also assumed that a defect was detected in the layer n−1, which defect has effects on the subsequent layers, and therefore the dismantling process is initiated. As has already been mentioned, the material removal device 700 is moved vertically downward relative to the print substrate 400, which is configured fixed in place in the vertical direction. The arrow indicates the direction in which the drive device 410 moves the material removal device 700, layer by layer. Regardless of the alternative placement of the drive device 410 as shown in this figure, the dismantling process functions in precisely the same manner as described above with reference to FIGS. 5 to 9 of the first exemplary embodiment.

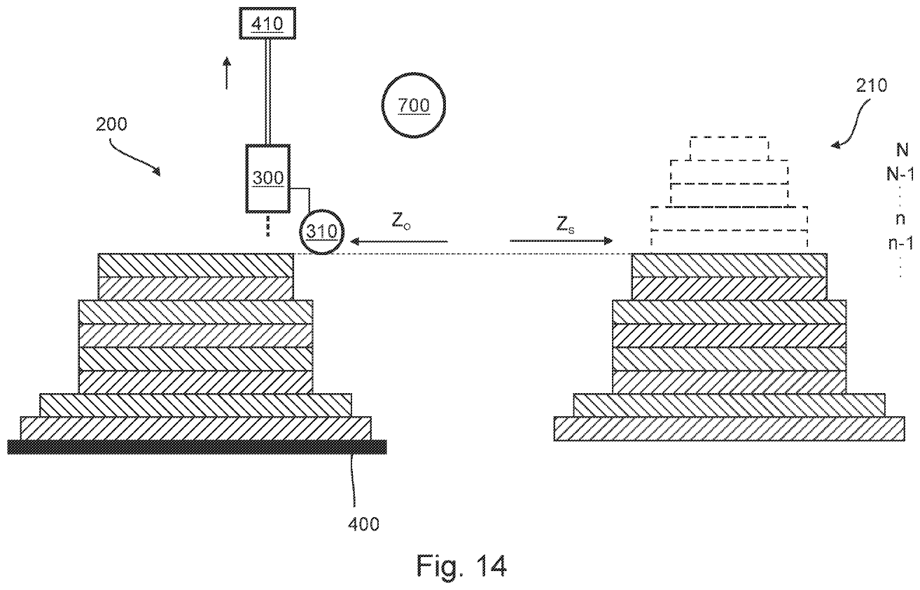

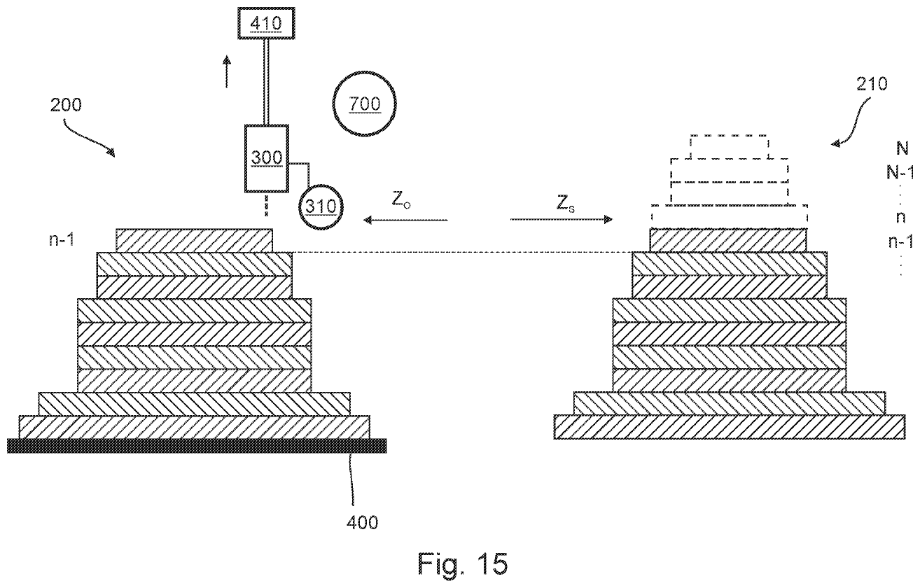

FIG. 14 shows how the material removal device 700 is in a parked position, since the material removal by means of the dismantling process has been concluded. The material dispensing device 300 is moved to the working position. Since the shaped object 200 was defective, the printing process now has to be started over again, so as to produce a defect-free shaped object 200. This material application begins in the layer n−1, at which the slicer indicator Z_{S} and also the object indicator Z_{O} are standing. As described above, the material application takes place by means of the material dispensing device 300; the leveling device 310 that follows the material dispensing device 300 prevents a material excess, and the shaped object 200 is newly built up. FIG. 15 illustrates the printing process, proceeding from the layer n−1, which was already completely built up anew in this view. The material dispensing device 300 is already standing at the next layer n, at which the slicer indicator Z_{S} in the image data and, accordingly, the object indicator Z_{O} are set.

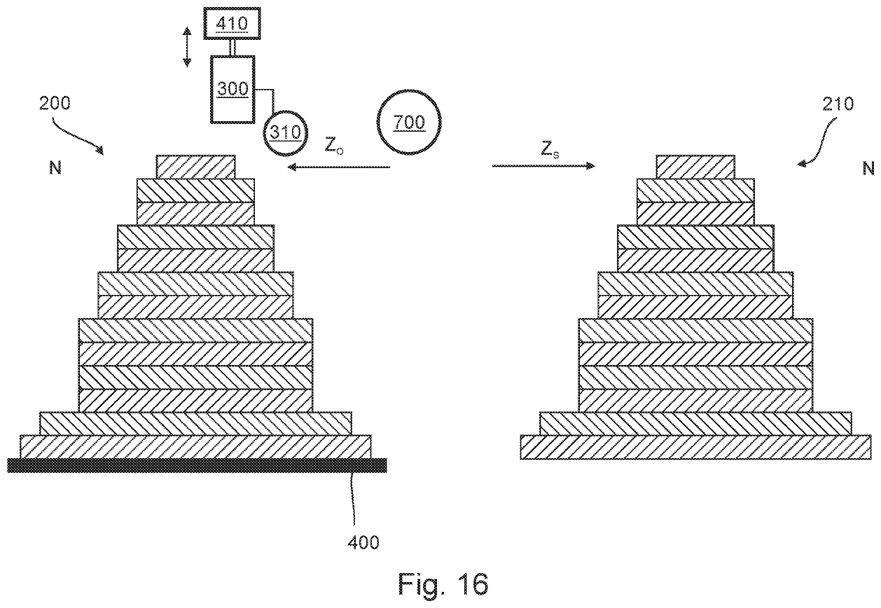

As can already be seen in the representation of the three-dimensional shaped object 200 on the left, in each instance, the previously defective layer Sₓ where x=n−1 is newly applied by the material dispensing device 300. The material application process is continued until the shaped object 200 is printed completely without defects; this is shown in FIG. 16. Analogous to FIG. 11 of the first exemplary embodiment, in this second exemplary embodiment the material dispensing device 300 has been moved back to the starting position again by the drive device 410, and the uppermost layer N has been completely applied. The material removal device 700 is in the parked position. The shaped object has been completed after defect-free material application. If the determination of a defect still took place before complete completion of the shaped object, then the printing process can be continued (after removal of damaged layers) until the shaped object has been completely completed. During this process, the removed layers are applied once again.

The material removal device 700 has a material removal tool that is suitable for full-area or complete removal of layers Sₓ of the shaped object 200. For this purpose, the material removal tool extends over the printing width of the shaped object to be printed, in other words it spans the print substrate in terms of its printed width.

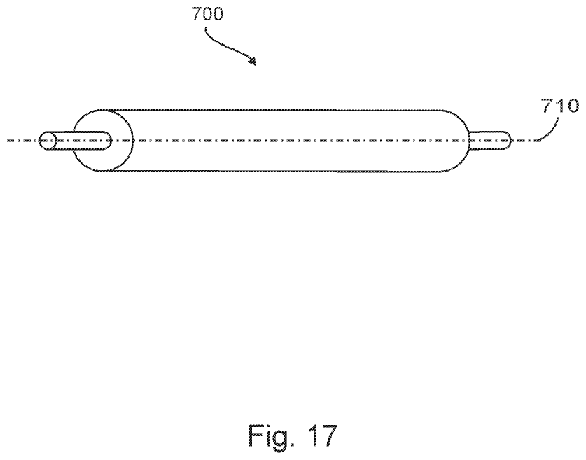

In FIGS. 17 to 19, exemplary embodiments of the material removal device 700 are shown in their perspective view, so as to illustrate that the material removal device 700 removes the material of one or more layers completely, in one work cycle.

FIG. 17 shows an embodiment of the material removal tool of the material removal device 700 in a longitudinal expanse along an axis 710. Only as an example, a milling machine is shown here. The material removal device 700 with its material removal tool can also be configured as further usual chip-cutting tools, without rotating about the axis 710. This holds true, in particular, for material removal tools that work in a planar manner, for example grinding, eroding or polishing material removal tools. The elongated material removal tool shown is suitable for a Cartesian system, since the material removal takes place uniformly over the full area, with a slight excess length beyond the width or the length of the print substrate 400, also called printing width, onto which the shaped object is applied. During the removal of the material, the elongated material removal tool of the material removal device 700 rotates about its axis 710. Since the dismantling process takes place independent of the type of defect, the local place of occurrence in a layer, and the size or dimension of a defect, the material is removed over the full surface area. To increase the speed, the layer can be removed not just over the full area, in other words completely, but rather—as has already been described in the other figures—multiple layers are also removed in this one working cycle of the material removal. Therefore, not only the productivity but also the quality of the three-dimensional shaped object 200 to be produced can increase, since the repair is not carried out in a minimalist manner but rather over a large surface area.

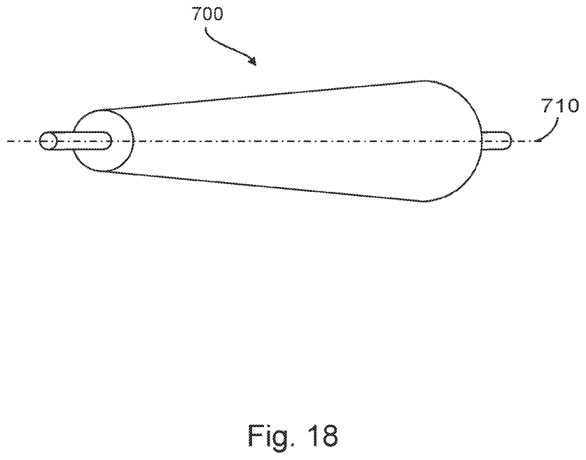

In FIG. 18, the elongated material removal tool of the material removal device 700 is shown in a conical embodiment, and also mounted so as to rotate about its axis 710. The elongated material removal tool is used for chip-removing machining in a polar printing system. As an example in this figure, as well, the material removal tool is shown so as to rotate, as it is used for milling away the defective layers. The material removal tool can also be configured to be fixed in place for chip-removing material removal along its axis 710.

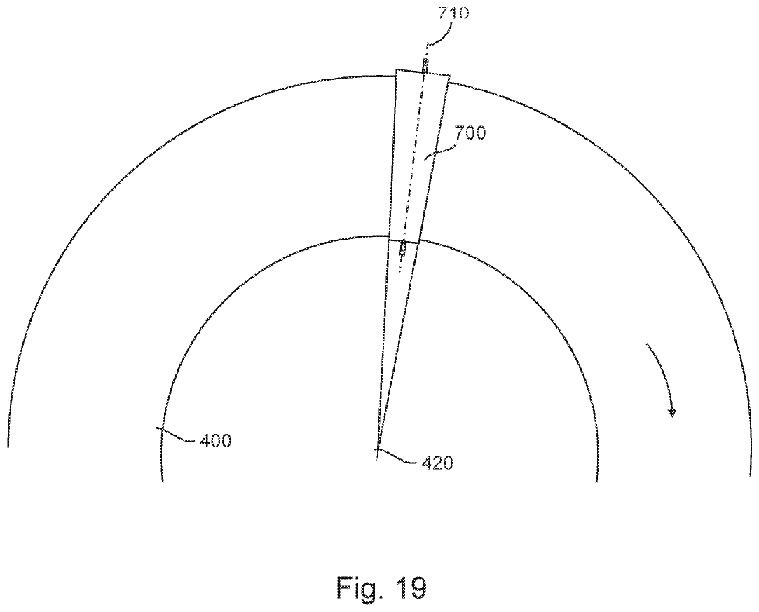

FIG. 19 shows, in a top view, the material removal device 700 for the exemplary embodiment according to FIG. 18. In this representation it can be seen how the material removal device 700 extends over the entire width of the region to be printed, analogous to the Cartesian system according to FIG. 17. In FIG. 19, a ring-shaped printed field of a rotating print substrate 400 is shown as the printed region. The material removal device 700 extends laterally, in each instance, beyond the imprintable region, so as to undertake material removal in one work pass, over the full area. The print substrate 400 has rotation symmetry to an axis of rotation 420.

### REFERENCE SYMBOL LIST

100 apparatus
200 shaped object
210 image data of the shaped object
300 material dispensing device
310 leveling device
400 print substrate
410 drive device
420 axis of rotation
500 control device
510 data memory
600 monitoring device
610 evaluation device
700 material removal device
710 axis
800 service station
T partial region
S layer
n n: {1 to N} where n=whole positive number
N last layer that was printed
x defective layerx: {1, . . . , N}
Zₒ object pointer
Z_{S} slicer pointer

1. An apparatus for producing a three-dimensional shaped object by means of material application in layers Sₙ where n=1 to N, having:
at least one material dispensing device for applying material that can be solidified physically or chemically to a print substrate or to a solidified layer Sₙ of the shaped object situated on it;
a drive device for positioning the print substrate and the at least one material dispensing device relative to one another;
a control device having a data memory, for storing image data of the three-dimensional shaped object, wherein the control device stands in a control connection with the drive device and the at least one material dispensing device;
a monitoring device for checking the layers Sₙ of the three-dimensional shaped object, wherein the monitoring device is followed by an evaluation device;
a material removal device, wherein the evaluation device and the material removal device stand in a control connection with the control device, and the material dispensing device is followed by a leveling device for leveling the layer Sₙ that has been applied, in each instance,
wherein
the evaluation device is configured for determining a layer Sₙ where n=x, in which layer at least one defect was detected by the monitoring device, for checking the layers Sₙ where n=x+1, x+2 . . . that follow the defective layer Sₓ for a defective geometry change of the shaped object, which change exceeds a predetermined dimension, for generating an error signal for the layer Sₓ in the case of a defective geometry change of the subsequent layers Sₙ where n=x+1, x+2 . . . , and for passing the generated error signal for this first one of the defective layers Sₓ on to the control device; that the material removal device is structured for removing the material of a partial region of the three-dimensional shaped objects, from the layer S_{N} last printed down to the first of the defective layers Sₓ, for which an error signal was generated, wherein the material removal device is configured in such a manner that during removal of the material, complete layers Sₙ can be removed.

2. The apparatus according to claim 1, wherein the partial region of the three-dimensional shaped objects comprises, from the last layer S_{N} that was printed, down to the defective layer Sₓ, at least one preferably complete layer Sₙ, in particular between two and four preferably complete layers Sₙ, preferably more than four preferably complete layers Sₙ.

3. The apparatus according to claim 1, wherein the material removal device is configured for chip-removing machining, in particular by means of milling, grinding, preferably polishing and/or scraping.

4. The apparatus according to claim 1, wherein the material removal device is configured in such a manner that during removal of the material, the thickness of one layer Sₙ or the thickness of at least two layers Sₙ can be removed, preferably completely.

5. The apparatus according to claim 1, wherein the monitoring device is configured as an optical monitoring device, in particular a CCD camera, a CCD camera in combination with a laser beam, an optical or mechanical scanning device, a device that measures layer thickness or a measuring laser.

6. The apparatus according to claim 1, wherein the material dispensing device is configured in such a manner that it can be brought into a parked position, at which a service station for checking a function problem of the material dispensing device and for correcting the possible function problem is arranged.

7. The apparatus according to claim 1, wherein the print substrate is mounted so as to rotate about an axis of rotation, relative to the at least one material dispensing device.

8. The apparatus according to claim 1, wherein the drive device is configured for positioning the material dispensing device relative to the print substrate, which is in a fixed position in the vertical direction, or for positioning the print substrate relative to the material dispensing device, which is fixed in place in the vertical direction.

9. The apparatus according to claim 1, wherein the material removal device has a material removal tool for chip-removing machining of the shaped object, wherein the material removal tool spans the print substrate in at least one expanse, in such a manner that the material removal device completely removes the layers S_{N} to Sₓ.

10. The apparatus according to claim 9, wherein the material removal device and print substrate can be moved relative to one another by a certain height, wherein the height is predetermined by the evaluation device in accordance with the partial region of the defective layers S_{N} to Sₓ of the shaped object that is to be removed, and that the material removal tool removes the complete layers S_{N} to Sₓ in one work step.

11. The apparatus according to claim 9, wherein the material removal tool of the material removal device has a longitudinal expanse along an axis, can rotate about its axis, and is configured to be cylindrical or conical.

12. A method for producing a three-dimensional shaped object by means of material application in layers Sₙ where n=1 to N, having the following steps:
applying material that can be solidified physically or chemically to a print substrate in layers Sₙ;
checking the three-dimensional shaped object with regard to at least one existing defect;
leveling each layer Sₙ that is applied, in each instance;
determining a layer Sₓ of the three-dimensional shaped object, in which layer the at least one defect was detected;
checking the subsequent layers Sₙ, where n=x+1, x+2 . . . , for defective geometry changes of the shaped object,
wherein
an error signal is generated for this first one of the defective layers Sₓ and passed on to a control device if a defective geometry change of the subsequent layers Sₙ where n=x+1, x+2 . . . was detected, which change exceeds a predetermined dimension;
the material application in layer S_{N} is stopped in accordance with the error signal;
in the image data of the shaped object, a slicer indicator is set to the first defective layer Sₓ;
a partial region of the three-dimensional shaped object is removed from the last layer S_{N} that was printed, down to the defective layer Sₓ for which an error signal was generated, wherein the layers S_{N} to layer Sₓ are completely removed, and
afterward the layers that were previously removed, and possible further layers are applied and checked, layer by layer, until completion of the shaped object.

13. The method according to claim 12, wherein the partial region of the three-dimensional shaped objects, of the last layer S_{N} that was printed, down to the defective layer Sₓ, comprises at least one preferably complete layer Sₙ, in particular between two and four preferably complete layers Sₙ, preferably more than four preferably complete layers Sₙ.

14. The method according to claim 12, wherein the layers Sₙ are removed by chip cutting, in particular by means of milling, preferably polishing, grinding and/or scraping.

15. The method according to claim 12, wherein during removal of the material, the thickness of one layer Sₙ or the thickness of at least two layers Sₙ is removed, preferably completely.

16. The method according to claim 12, wherein the print substrate is rotated about an axis of rotation.

17. The method according to claim 12, wherein a material dispensing device is positioned relative to the print substrate, which is fixed in place in the vertical direction, or the print substrate is positioned relative to the material dispensing device, which is fixed in place in the vertical direction, by means of a drive device.

18. The method according to claim 12, wherein an object indicator follows the slicer indicator until the first defective layer Sₓ has been reached.

19. The method according to claim 12, wherein the layers are applied to the print substrate or to the solidified layer of the shaped object that is situated on it by means of a material dispensing device, and that between the generation of the error signal and the subsequent application of a new layer Sₙ, the material dispensing device is checked for a function problem, and—if a function problem is detected during this process—it is corrected.

20. The method according to claim 12, wherein the layers S_{N} to layer Sₓ are completely removed in one work cycle.
